(19) United States
(12) Patent Application Publication
(10) Pub. No.: US 2007/0134626 A1
(43) Pub. Date: Jun. 14, 2007

(54) Book and method for enhancing collective group reading activity

(76) Inventor: Allison C. Hall, Lake Villa, IL (US)

Correspondence Address: MERONI + MERONI, P.O. BOX 309, BARRINGTON, IL, 60011, US

(21) Appl. No.: 11/301,495

(22) Filed: Dec. 13, 2005

(51) Int. Cl. G09B 19/00

(52) U.S. Cl. 434/118; 434/317

(57) ABSTRACT

A customizable book system enhances the collective reading activity of a classroom group. The book system comprises a book assembly, a lesson-specific storyline; and certain name-installing software. The book assembly comprises an outer cover and a plurality of pages. The cover provides a title-receiving medium and certain photograph-displaying structure for displaying a group-customized photograph. The pages are disposed intermediate the cover for providing a storyline medium. The lesson-specific storyline comprises a plurality of student-assignable, unnamed characters and at least one faculty-assignable, unnamed character. The name-installing software functions to assign the named students and the named faculty to the assignable, unnamed characters via certain identifier. After name assignments have been made and names have been inserted into the storyline, the storyline may then be output upon certain data-outputting structures for provision to members of the student body or readership group.

### BACKGROUND OF THE INVENTION

1. Field of the Invention

The present invention generally relates to a customizable book for group-based users. More particularly, the present invention relates to a customizable book and method for presenting lesson-specific storylines to a group of readers and/or students as a means to enhance the collective reading activity and learning potential for the group.

2. Description of the Prior Art

The prior art teaches a variety of methods and products reflective of customizable books and teaching aids for aiding readers in their quest for knowledge. In this regard, it is noted that books have long served as fundamental media for yielding knowledge or understanding to its readers. Several of the more pertinent disclosures relating to the present invention are briefly described hereinafter.

U.S. Pat. No. 5,114,291 ('291 patent), which issued to Hefty, discloses a Method of Making Peronalized Children's Storybook. The '291 patent teaches a method of making a book. More particularly, the invention pertains to a method of making a personalized children's storybook using a computer to form text pages having pre-stored, non-variable text merged with personalized, variable text to create an individualized story line. The method of the invention utilizes a personal computer and a laser printer to make text pages for a personalized children's storybook. The text pages include non-variable text and variable text. The non-variable text comprises general information which does not change or vary from book to book of the same title. The variable text comprises specific information which changes or varies for each book depending on the recipient of the book.

U.S. Pat. No. 5,213,461 ('461 patent), which issued to Kalisher, discloses a Method for Rapidly Generating Personalized Books while a Purchaser Waits. The '461 patent relates generally to the creation of books or documents and, more particularly, to a process for rapidly generating personalized books while a purchaser waits. In carrying out the method of the present invention, a series of steps is performed that includes loading a program having a predetermined story stored therein into a computer, entering personalized data into the computer to create a personalized story therefrom, feeding into a printing device a set of sheets having a first and second side, printing the personalized story on one of the sides of the sheets, separating the sheets transversely into pages, assembling the pages in a predetermined order and the fastening the assembled pages to a book jacket to form a personalized book. The sheets used in the disclosed method are preferably standard size, coated paper and have a partially preprinted design or illustration that partially covers the top side of each sheet, leaving blank areas for the story text, and fully covers the bottom side of the sheets.

U.S. Pat. No. 5,397,156 ('156 patent), which issued to Schach et al., discloses a Personalized Book Kit. The '156 patent teaches a kit which enhances the marketability of personalized books, such as paperback romance novels. The kit includes a simulated book constructed of a book cover and foam core adhesively secured to it, and a questionnaire for insertion of personalized information. The questionnaire and a reply addressed envelope are provided between the cover and the foam core, and the simulated book is shrink-wrapped in transparent plastic. The questionnaire is on difficult to accurately photocopy paper, such as colored paper and/or ink with a distinctive watermark or printed background design, and/or a serial number (e.g. in bar code format). Instructions on what to do with the questionnaire are provided on the rear face of the simulated book cover. The kit is sold for a price that includes printing and delivery of the basic personalized book, and when a completed original questionnaire is received the personalized book is printed utilizing as part of the text of the book the personalized information on the questionnaire, and is delivered to the purchaser.

U.S. Pat. No. 5,782,598 ('598 patent), which issued to Salzberger, discloses a Personalized Paper Book Cover. The '598 patent teaches a “while you wait” process which takes a book buyer's picture and inserts it, with a caption, onto the back of a purchased book's paper-cover. The customer looks into a video camera and/or supplies a photograph, which is scanned into a computer. The book's cover is also entered into the computer and is there edited to incorporate the picture and the text of a caption. The customized cover is then achieved on the store's printer. Alternatively, a publisher provides paper book-covers containing spaces free of text and graphics. The customer's captioned pictures are then printed onto these voids.

U.S. Patent Application Publication No. US 2002/0077848 A1 ('848 Publication), authored by Campbell, discloses a Method for Creation of a Customized Book. The '848 Publication teaches a method of creating a customized product. The invention includes presenting a customizable template to a customer who then, as an customer, provides the names of peoples, pets, and places that the reader or customer is familiar with for incorporation into the book. The customer also presents to the service provider copies of images that are incorporated into the story for further customization. Once the names and images and other customizable story variations are selected by the customer, the book is then published and sent. The customized product may include a book, game, toy, business training aid, or other products, such promotional material.

From a review of the above-referenced patents and other prior art generally known to exist, it will be noted that the prior art does not teach a customizable book that functions to incorporate an entire organization or group of commonly-situated readers (such as a classroom-type group of students) into a single instructive storyline structure and which identifies the members of the group by visual stimuli (such as class photographs, and the like). The prior art thus perceives a need for a customizable book that functions to incorporate an entire organization or group of commonly-situated readers (such as a classroom-type group of students) into a single instructive storyline structure and which identifies the members of the group by visual stimuli (such as class photographs, and the like).

### SUMMARY OF THE INVENTION

Accordingly, it is an object of the present invention to provide a customizable book system or storyline system for enhancing collective group reading activity of classroom based students or similar other readership group. To achieve this and other readily apparent objectives, the present invention provides a customizable book system for generally enhancing the collective reading activity of a classroom group. The book system preferably comprises a book assembly, a lesson-specific storyline; and certain name-installing means. The book assembly comprises an outer cover and a plurality of pages.

The cover comprises a title-receiving medium and certain photograph-displaying means for displaying a group-customized photograph. The pages are disposed intermediate the cover for providing a storyline medium.

The lesson-specific storyline may be stored in a storyline bank or library. The storyline bank may preferably comprise a plurality of lesson-categorized, size-dependent stories from which the lesson-specific storyline may be selected based upon the group size and lesson plan being addressed. The chosen lesson-specific storyline preferably comprises a plurality of student-assignable, unnamed characters and at least one faculty-assignable, unnamed character. Each student-assignable, unnamed character of the storyline may preferably be identified with a student identifier and each faculty-assignable, unnamed character may preferably be identified with a faculty identifier.

The lesson-specific storyline may preferably further comprise certain group-familiar, environment-assignable elements. Generally, it is contemplated that the select group-familiar, environment-assignable elements may be selected from the group consisting of group-familiar geographical elements, group-familiar physical elements; and group-familiar social elements. The group-familiar, environment-assignable elements are each preferably identified with a select elemental identifier. The select elemental identifier may be selected from the group consisting of a default environmental identifier and an option-filled environmental identifier.

The name-installing means function to randomly assign the named students to the student-assignable, unnamed characters via the student identifiers and further function to directly assign faculty member(s) to the faculty-assignable, unnamed characters via the faculty identifier(s). After name assignments have been made and names have been inserted into the storyline, the storyline may then be output upon certain data-outputting means for provision to members of the student body or readership group.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of my patent drawings, as follows:

FIG. 1 is a screenshot depicting a categorical listing of faculty names, student names, and a single environmental attribute as highlighted by underlining.

FIG. 2 is a top perspective view of a book assembly of the present invention showing a cover displaying a group-customized title and a group photograph.

FIG. 3 is a plan view of two pages of the book assembly of the present invention illustrating a portion of a storyline having assigned and inserted student names and faculty names, and at least one environmental attribute.

### DETAILED DESCRIPTION OF THE PREFERRED EMBODIMENT

The preferred embodiment of the present invention concerns a customizable book system for generally enhancing the collective reading activity of a classroom group or similar other readership group. Young readers who are grouped in classroom settings are commonly provided certain reading materials as teaching or learning aids. Notably, classroom groups are typically cohesive groups wherein the members often strongly identify with the group. As an example, students under the tutelage of “Mrs. Clarke,” may readily identify themselves as belonging to Mrs. Clarke's class. With these particular notions in mind, the disclosed book system and methodology are presented.

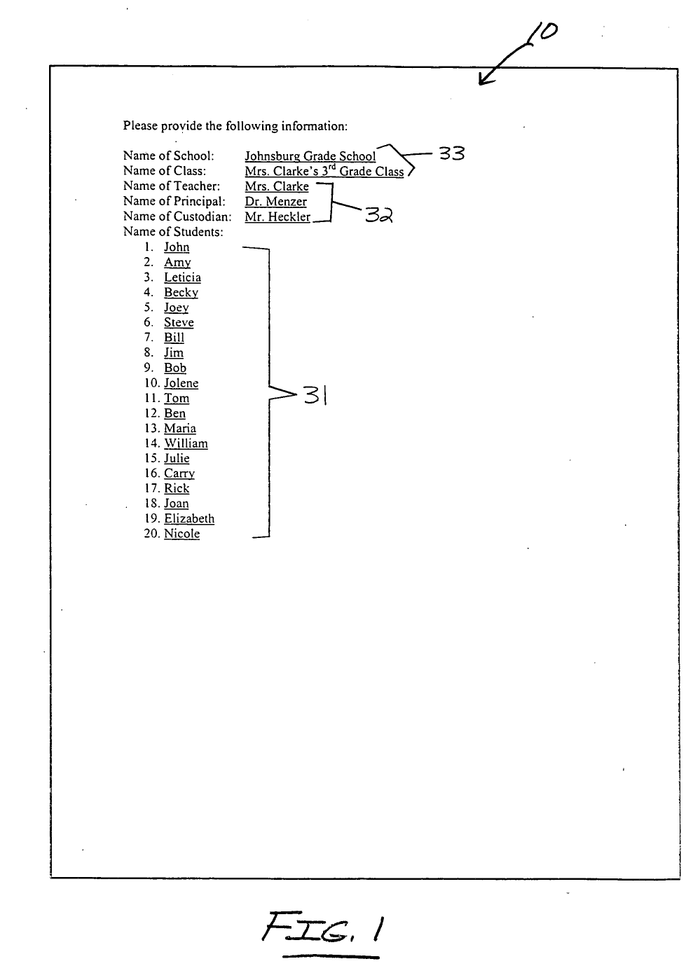

The target classroom group or similar other readership group will inherently have a group size typically on the order of 20-30 members, but may be as few as 3 members (for example, two students and a single faculty member or instructor) and as great as 40 members (for example, thirty-five students and five faculty or administrative members). Essentially, however the target classroom or readership group will comprise a plurality of named students and at least one named faculty member, such as the teacher, principal, custodian, or similar other administrative agent. The named students and faculty member(s) may thus be listed in a categorical listing 10 as generally illustrated and referenced in FIG. 1.

From an inspection of the noted figure, it will be seen that certain administrative personnel are listed separately from the student names. A distinction is thus made between the named students and faculty members. In this regard, it is noted that the focus of the disclosed book system is on the students' involvement and to a lesser extent on the named faculty. In other words, the students are the players or problem solvers in the book system and the faculty members play a secondary guiding role in the various storylines that may be presented. Thus, it is important to categorize the primary characters from the secondary characters in the listing so that certain name-installing means or name-assigning means may assign students to primary character roles and faculty members to secondary character roles, which is discussed in more detail hereinafter.

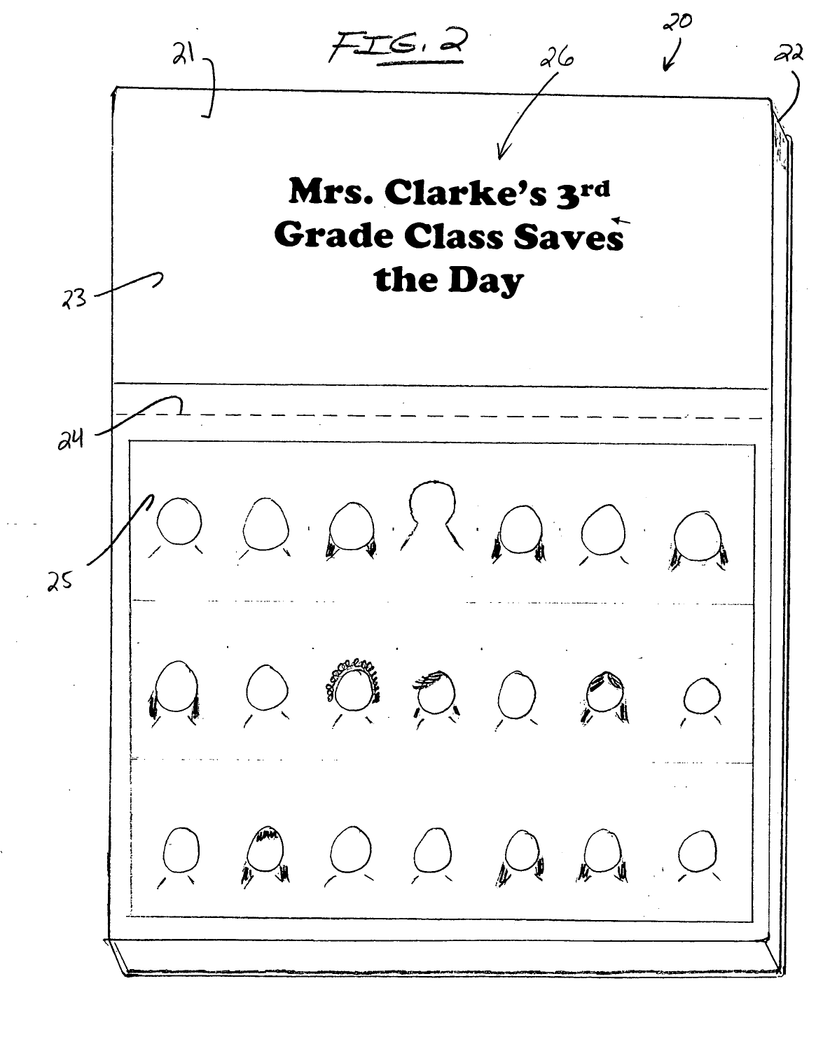

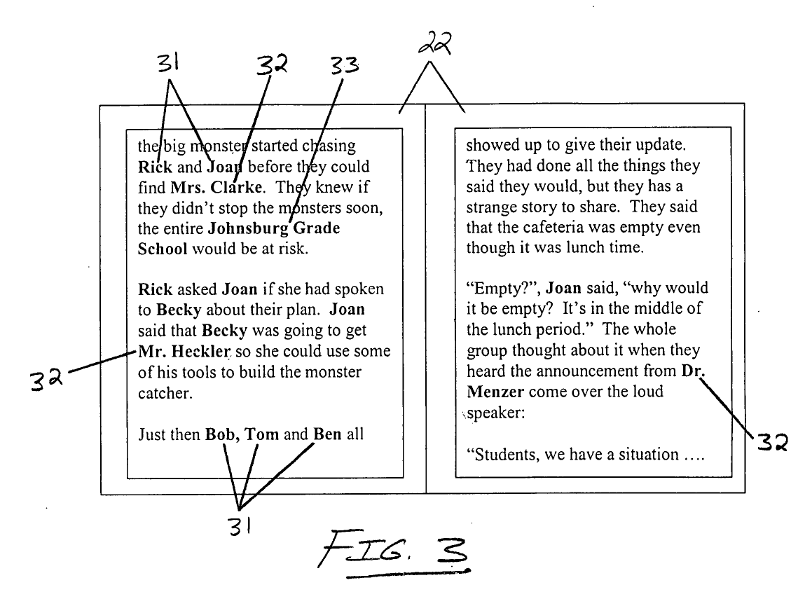

The book system preferably comprises a book assembly 20 as generally illustrated and referenced in FIG. 2; a lesson-specific storyline; and certain name-installing means. It will be seen from an inspection of FIG. 2 that book assembly 20 preferably comprises certain physical elements including an outer cover 21 and a plurality of pages 22 (two of which pages 22 are further referenced in FIG. 3). The cover 21 preferably comprises a title-receiving medium 23 and certain photograph-displaying means. It is contemplated that the preferred photograph-displaying means may be defined by a translucent photograph-receiving pocket 24 integrally formed with the cover 21 for receiving and displaying a classroom group photograph 25 as further generally and generically depicted in FIG. 2.

Notably, any number of means may well function to display a group-customized photograph for clearly identifying the target group. In this regard, it is contemplated that the group photograph 25 may be displayed upon cover 21 by way of adhesive attachment or by integrally printing the photograph upon a cover jacket (which may also serve as the title-receiving medium 23). It is contemplated that a translucent photograph-receiving pocket 24 may well function to aid the user to interchange group photographs and to minimize damage to cover 21. The pages 22 are disposed intermediate the cover 21 for providing a storyline medium. It is thus contemplated that the classroom group photograph 25 may be cooperatively associated with the photograph-displaying means for group-customizing the cover 21 to further enhance the collective reading activity of the classroom group by identifying the members of the group in a single, visual, cover-borne manner.

The lesson-specific storyline may preferably be pre-composed and electronically stored for later name/noun/attribute insertion. In this regard, it is contemplated that the storyline or storylines may be stored in a storyline bank or library. The storyline bank may preferably comprise a plurality of lesson-categorized, size-dependent, genre-specific stories from which the lesson-specific storyline may be selected based upon the group size; the lesson plan being addressed; and the desired genre of writing.

The chosen lesson-specific storyline preferably comprises a plurality of student-assignable, unnamed characters and at least one faculty-assignable, unnamed character. In other words, the storyline comprises certain voids where names may be inserted. In this regard, the system provides for a number of primary student assignable characters, randomly assignable to the students in the classroom group so that each student may play a role in the outcome of the storyline, but which characters are left unnamed at the outset so that the same may be filled with student names per the printer's (or book assembler's) election. Each student-assignable, unnamed character of the storyline may preferably be identified with a student identifier, such as an electronic place-holding primary address. Similarly, each faculty-assignable, unnamed character may preferably be identified with a faculty identifier, such as an electronic place-holding secondary address. Notably, the student identifiers and the faculty identifiers are of a different class or type, the former being randomly assignable and the latter being directly assignable, the distinction being primary versus secondary place holders. This structure enables certain name-installing or name-assigning means, as may be achieved via certain name-assigning software, to assign student names to certain primary or student identifiers and further to assign faculty name(s) to certain secondary or faculty identifiers for installation into the storyline. Notably, the student-assignable and faculty-assignable characters cooperate within the storyline to solve a lesson-specific problem as an instructional aid to the target group.

The lesson-specific storyline may preferably further comprise certain select group-familiar, environment-assignable elements such as name of one's school as generally depicted in FIG. 1. Generally, it is contemplated that the select group-familiar, environment-assignable elements may be selected from the group consisting of group-familiar geographical elements (for example, the village in which the class is located); group-familiar physical elements (for example, a mascot and/or school colors); and group-familiar social elements (for example, classroom or group rules of etiquette). In this regard, the categorical listing may thus comprise or otherwise provide for named environmental-assignable attributes such as “Johnsburg Grade School” as seen in FIG. 1 or certain default terminology such as “ACME Grade School” if the option is not taken to provide an environmental-assignable attribute.

The group-familiar, environment-assignable elements are each preferably identified with a select elemental identifier (such as an electronic place-holding tertiary address). The select elemental identifier may, however, be selected from the group consisting of a default environmental identifier (for those instances in which the user does not elect to provide a named environmental attribute) and an option-filled environmental identifier (for those instances in which the user does elect to provide a named environmental attribute).

The name-installing means (as may preferably be defined by name-installing software) preferably randomly assigns the named students to the student-assignable, unnamed characters via the student identifiers and directly assigns at least one named faculty member to the faculty-assignable, unnamed character via the faculty identifier. In other words, provided a categorized list of names (student versus faculty), the name-installing means function to randomly assign student names to the primary characters in the storyline and further function to directly assign faculty names to the secondary characters in the storyline.

In this last regard, it is contemplated that in order to preserve proper classroom decorum, students are to be randomly assigned to student type characters (all of which have certain (socially) equal roles) and faculty members are to be directly assigned to faculty-type predefined characters reflective of the actual faculty role the faculty member plays. By electronically assigning student names and faculty names to certain character roles, the names are virtually automatically installed into the storyline. The storyline may then be output upon certain data-outputting means for further book assembly. The name-installing means may further function to directly assign the named environmental attributes or default terminology to the group-familiar, environment-assignable elements via the select elemental identifiers.

Referring now to FIG. 3, it will be seen that Rick, Joan, Becky, Bob, Tom and Ben are named as primary, “student-named” characters 31 in the portion of the storyline there re-presented as achieved via random assignment. Further, Mrs. Clarke, Mr. Heckler, and Dr. Menzer are named as secondary, “faculty-named” characters 32 as achieved by direct assignment based upon typical faculty roles. For example, Mr.

Heckler is the school custodian and would typically have a certain tools with which the students could build a so-called “monster catcher”. Notably, Johnsburg Grade School is also named as the specific, personally known school setting, but could just as easily have been identified by, “the Grade School” if the user had not listed a specific environmental attribute and a default term was used. “Johnsburg Grade School” is representative of a group-familiar, environment-assignable element 33.

Preferably, the storyline may be printed out via typical word-processing means upon a printing machine thus enabling a printer or book assembler to fix the storyline upon the storyline medium (i.e. the pages 22) and further to fix a group-customized title 26 upon the title-receiving medium as generally referenced in FIG. 2. It is contemplated that by placing students into a story there is an increase in the students' attention, retention, and comprehension of the story. Additional instruction may be included to support the story such as science experiments or history lessons.

In this last regard, it is further contemplated that the lesson-specific storyline may preferably comprise a science-based lesson to solve a lesson-specific problem addressed in the lesson-specific storyline. Further, the lesson-specific storyline may preferably comprise a genre-specific storyline such as a mystery type story having a solvable ending. The science-based lesson may thus be utilized to solve the solvable ending of the mystery. Thus, the customizable book system may function to enhance the collective reading activity of the classroom group.

It is further contemplated that the disclosed system further inherently teaches certain methodology for enhancing the collective reading activity of a readership group or a classroom group. In this regard, the method comprises the steps of compiling or pre-compiling a storyline bank or library comprising at least one story, but preferably a diverse array of stories, each of which have a plurality of assignable unnamed characters, a genre-specific storyline, and at least one science-based lesson supportive of the genre-specific storyline. The genre-specific storyline may preferably be defined by a mystery having a solvable ending, the science-based lesson being usable to solve the solvable ending.

Each assignable unnamed character is identified by a character identifier (such as earlier specified), which assignable unnamed characters coact within the genre-specific storyline to fulfill the story. Given a precompiled storyline bank, the methodology includes selectively listing select member names or attributes of a readership group (having a certain group size). In this regard, it is contemplated that when students form the bulk of the readership group, first or given student names will suffice to fill the primary characters of the storyline and surnames coupled with conventional titles of courtesy such as “Mr.”, “Mrs.”, or “Dr.” and the like will suffice to fill the secondary characters of the storyline. Thus, the select member attributes may be selected from the group consisting of a given name and a surname.

After listing the names and/or attributes, at least one group-providable story is selected from the storyline bank as based upon the group size and the desired genre-specific storyline. In other words, certain stories as found in the storyline bank will have sufficient character spots to match with readership groups of varying sizes and further comprise certain types of stories such as mysteries or the like per the user's election.

From the storyline library or storyline bank, the group-providable story is selected after which the select member attributes or names are assigned to the assignable unnamed characters via the character identifiers and thus inserted into the storyline. The select member names may be selectively assigned via a select assignment process, the select assignment process being selected from the group consisting of random character assignment and structured character assignment. The structured character assignment may preferably be based upon predefined assignment rules, such as assigning names by gender-based criteria or similar other readily distinguishable criteria.

Once the names have been assigned and inserted, each member of the readership group may then be provided with a copy of the group-providable story for structured group reading activity. The copy of the group-providable story may preferably be provided to each member of the readership group in book form, the book form comprising an outer cover (such as cover 21) and at least one page. The cover may preferably comprise certain photograph-displaying means for displaying a readership group photograph and for otherwise group-customizing the cover.

While the above description contains much specificity, this specificity should not be construed as limitations on the scope of the invention, but rather as an exemplification of the invention. For example, as is described hereinabove, it is contemplated that the essence of the invention teaches a customizable storyline system for providing a readership group with a member-based story. In other words, the storyline will include all members of the group participating in the collective group reading activity. The readership group thus inherently has some group size and comprises a plurality of named readers. The named readers are prefatorily compiled in a group listing. The storyline system comprises a genre-specific storyline and certain name-assigning means. The genre-specific storyline comprises a plurality of assignable characters each of which may be identified with a character identifier such as an electronic place-holding address or similar other identifier. The assignable characters coact or cooperate within the storyline to fulfill the story. The name-assigning means selectively assign named readers from the group listing to the assignable characters via the character identifiers and the customizable storyline system provides the readership group with a member-based story.

The name-assigning means may selectively assign named readers to the assignable characters via a select assignment process, the select assignment process being selected from the group consisting of random character assignment and structured character assignment. The name-assigning means may comprise certain name-installing means for placing the named readers into the fillable, multi-character storyline. The storyline may then be preferably placed on hard copy in a book assembly, the book assembly comprising an outer cover and at least one page. The cover may preferably comprise a title-receiving medium and at least one page may be disposed intermediate the cover for providing a storyline medium. The name-installing means enable a book assembler to cooperatively associate the storyline with the storyline medium and a group-customized title with the title-receiving medium. The cover may further comprise certain photograph-displaying means for displaying a readership group photograph or for otherwise group-customizing the cover.

The customizable storyline system may further preferably comprise a storyline bank or library. The group size from group to group is notably variable and in this regard, it is preferred that the storyline bank comprise a plurality of genre-specific, size-dependent stories. The genre-specific storyline may then be selected from the genre-specific, size-dependent stories based upon the group size and the desired genre. The genre-specific storyline may comprise group-familiar, environment-assignable elements and the group listing may comprise named environmental attributes. The group-familiar, environment-assignable elements are being identifiable with a select elemental identifier, the select elemental identifier being selected from the group consisting of a default environmental identifier and an option-filled environmental identifier. The name-assigning means directly assign named environmental attributes to the group-familiar, environment-assignable elements via the select elemental identifiers.

Accordingly, although the invention has been described by reference to a preferred embodiment, it is not intended that the novel assembly be limited thereby, but that modifications thereof are intended to be included as falling within the broad scope and spirit of the foregoing disclosure, the following claims and the appended drawings.

I claim:

1. A customizable book system for enhancing the collective reading activity of a classroom group, the classroom group having a group size and comprising a plurality of named students and at least one named faculty member, the named students and the named faculty member being listed in a categorical listing, the book system comprising:
a book assembly, the book assembly comprising an outer cover and a plurality of pages, the cover comprising a title-receiving medium, the pages being disposed intermediate the cover for providing a storyline medium;
a lesson-specific storyline, the lesson-specific storyline comprising a plurality of student-assignable, unnamed characters and at least one faculty-assignable, unnamed character, each student-assignable, unnamed character being identified with a student identifier, each faculty-assignable, unnamed character being identified with a faculty identifier, the student-assignable and faculty-assignable characters cooperating within the storyline to solve a lesson-specific problem; and
name-installing means, the name-installing means randomly assigning named students to the student-assignable, unnamed characters via the student identifiers and assigning the named faculty member to the faculty-assignable, unnamed character via the faculty identifier, the name-installing means enabling a book assembler to fix the storyline upon the storyline medium and fix a group-customized title upon the title-receiving medium, the customizable book system thus for enhancing the collective reading activity of the classroom group.

2. The customizable book system of claim 1 comprising a classroom group photograph, the cover comprising photograph-displaying means, the classroom group photograph being cooperatively associated with the photograph-displaying means for group-customizing the cover to further enhance the collective reading activity of the classroom group.

3. The customizable book system of claim 1 wherein all named students are assigned to the student-assignable, unnamed characters via the student identifiers.

4. The customizable book system of claim 1 wherein the lesson-specific storyline comprises at least one science-based lesson to solve the lesson-specific problem.

5. The customizable book system of claim 4 wherein the lesson-specific storyline comprises a mystery, the mystery having a solvable ending, the science-based lesson being usable to solve the solvable ending.

6. The customizable book system of claim 1 wherein the group size has a group size maximum and a group size minimum, the group size maximum being 40 and the group size minimum being 3.

7. The customizable book system of claim 6 comprising a storyline bank, the storyline bank comprising a plurality of lesson-categorized, size-dependent stories the lesson-specific storyline being selected from the lesson-categorized, size-dependent stories based upon the group size.

8. The customizable book system of claim 1 wherein the lesson-specific storyline comprises group-familiar, environment-assignable elements and the categorical listing comprises named environmental attributes, the group-familiar, environment-assignable elements each being identified with a select elemental identifier, the select elemental identifier being selected from the group consisting of a default environmental identifier and an option-filled environmental identifier, the name-installing means directly assigning named environmental attributes to the group-familiar, environment-assignable elements via the select elemental identifiers.

9. The customizable book system of claim 8 wherein the select group-familiar, environment-assignable elements are selected from the group consisting of group-familiar geographical elements, group-familiar physical elements, and group-familiar social elements.

10. A customizable storyline system for providing a readership group with a member-based story, the readership group having a group size and comprising a plurality of named readers, the named readers being compiled in a group listing, the storyline system comprising a genre-specific storyline and name-assigning means, the genre-specific storyline comprising a plurality of assignable characters, each assignable character being identified with a character identifier, the assignable characters coacting within the storyline, the name-assigning means selectively assigning named readers from the group listing to the assignable characters via the character identifiers, the customizable storyline system for providing the readership group with a member-based story.

11. The customizable storyline system of claim 10 wherein the name-assigning means selectively assign named readers to the assignable characters via a select assignment process, the select assignment process being selected from the group consisting of random character assignment and structured character assignment, the structured character assignment being based upon predefined assignment rules.

12. The customizable storyline system of claim 11 comprising name-installing means and a book assembly, the book assembly comprising an outer cover and at least one page, the cover comprising a title-receiving medium, the page being disposed intermediate the cover for providing a storyline medium, the name-installing means enabling a book assembler to cooperatively associate the storyline with the storyline medium and a group-customized title with the title-receiving medium.

13. The customizable storyline system of claim 12 wherein the cover comprises photograph-displaying means, the photograph-displaying means for displaying a readership group photograph and for group-customizing the cover.

14. The customizable storyline system of claim 11 comprising a storyline bank, the group size being variable, the storyline bank comprising a plurality of genre-specific, size-dependent stories, the genre-specific storyline being selected from the genre-specific, size-dependent stories based upon the group size.

15. The customizable storyline system of claim 11 wherein the genre-specific storyline comprises group-familiar, environment-assignable elements and the group listing comprises named environmental attributes, the group-familiar, environment-assignable elements each being identified with a select elemental identifier, the select elemental identifier being selected from the group consisting of a default environmental identifier and an option-filled environmental identifier, the name-assigning means directly assigning named environmental attributes to the group-familiar, environment-assignable elements via the select elemental identifiers.

16. A method for enhancing the collective reading activity of a readership group, the method comprising the steps of:
compiling a storyline bank, the storyline bank comprising at least one story, each story having a plurality of assignable unnamed characters and a genre-specific storyline, each assignable unnamed character being identified by a character identifier, the assignable unnamed characters coacting within the genre-specific storyline;
selectively listing select member names of a readership group, the readership group having a group size;
selecting at least one group-providable story from the storyline bank, the group-providable story being selected based upon the group size and the genre-specific storyline;
selectively assigning select member names to the assignable unnamed characters via the character identifiers;
inserting the select member names into the storyline; and
providing each member of the readership group with a copy of the group-providable story for structured group reading activity.

17. The method of claim 16 wherein the select member names are selectively assigned via a select assignment process, the select assignment process being selected from the group consisting of random character assignment and structured character assignment, the structured character assignment being based upon predefined assignment rules.

18. The method of claim 17 wherein the select member names are selected from the group consisting of a given name and a surname.

19. The method of claim 16 wherein the storyline comprises at least one science-based lesson supportive of the genre-specific storyline.

20. The method of claim 19 wherein the genre-specific storyline is defined by a mystery, the mystery having a solvable ending, the science-based lesson being usable to solve the solvable ending.

21. The method of claim 16 wherein the copy of the group-providable story is provided to each member of the readership group in book form, the book form comprising an outer cover and at least one page, the cover comprising photograph-displaying means, the photograph-displaying means for displaying a readership group photograph and for group-customizing the cover.
